(19) United States
(12) Patent Application Publication
(10) Pub. No.: US 2018/0067307 A1
(43) Pub. Date: Mar. 8, 2018

(54) HEADS-UP DISPLAY WINDSHIELD

(71) Applicant: Dura Operating, LLC, Auburn Hills, MI (US)

(72) Inventors: Michael Liubakka, Northville, MI (US); Ben Saltsman, Bloomfield Twp., MI (US); Teo Bal, Waterford, MI (US); Cumhur Unveren, Commerce Twp, MI (US)

(21) Appl. No.: 15/255,689

(22) Filed: Sep. 2, 2016

(51) Int. Cl. G02B 27/01; G09G 5/14; G09G 3/3208; G09G 3/02; G09G 3/20; B60K 35/00; G01C 21/26; G01C 21/36

(52) U.S. Cl. CPC G02B 27/0101; G09G 5/14; G09G 3/3208; G09G 3/02; G09G 3/2096; G06T 11/001; G01C 21/265; G01C 21/3667; G09G 2380/10; G06T 2210/62; B60K 35/00

(57) ABSTRACT

A motor vehicle heads-up display system includes an organic light emitting diode (OLED) screen positioned in contact with a motor vehicle windshield. The OLED screen includes a screen portion used to display augmented reality projection data. Multiple transparent display portions individually display vehicle related data and infotainment related data including at least a first transparent display portion, a second transparent display portion, and a third transparent display portion. A transparency level of each of the multiple transparent display portions can be varied. An instrument cluster display is presented on the first transparent display. A camera presentation of a motor vehicle left-hand side view is presented on the second transparent display. A camera presentation of a motor vehicle right-hand side view is presented on the third transparent display. One of the multiple transparent display portions is positioned in direct line-of-sight view of a passenger of the motor vehicle.

### FIELD

The invention relates generally to heads-up displays for motor vehicles.

### BACKGROUND

The statements in this section merely provide background information related to the present disclosure and may or may not constitute prior art.

Motor vehicle windshield heads-up displays (HUDs) are known which allow a driver to view vehicle conditions including vehicle speed. Known HUDs can be projected onto the windshield inner surface as a holographic image from an image projector located in the front dashboard or a proximate location. Such displays are commonly limited to an area immediately above the dashboard, and include very limited vehicle operator desired data. Known displays are also limited to a holographic projection, which only the vehicle driver can see, and do not include data which a front seat passenger can see or access.

This field can therefore benefit from improved HUD designs.

### SUMMARY

According to several aspects, a motor vehicle heads-up display system includes an organic light emitting diode (OLED) screen positioned in contact with a vehicle window. The OLED screen includes a screen portion used to display augmented reality (AR) projection data. At least two transparent display portions display vehicle related data and infotainment related data including at least an instrument cluster display.

In one aspect, the at least two transparent display portions include a first transparent display portion, a second transparent display portion, and a third transparent display portion.

In another aspect, the first transparent display portion is positioned below the screen portion.

In another aspect, the second transparent display portion is positioned to a driver's left of both of the screen portion and the first transparent display portion, and the third transparent display portion is positioned to the driver's right of both the screen portion and the first transparent display portion.

In another aspect, a display control unit is in communication with the screen portion and each of the transparent display portions which controls a content and selects a presentation of material transmitted for viewing in the screen portion and each the transparent display portions.

In another aspect, the at least two transparent display portions include a first optional transparent display portion located at any position proximate an upper edge of the OLED screen.

In another aspect, the at least two transparent display portions include a second optional transparent display portion positioned in a direct line-of-sight view of a passenger of the motor vehicle.

In another aspect, the first optional transparent display portion presents a pop-up warning to visually warn the operator of the motor vehicle of a close proximity of a second vehicle; and an object such as another vehicle or a pedestrian present in the range of a camera presentation of a vehicle left-hand side view or a camera presentation of a vehicle right-hand side view.

In another aspect, the second transparent display portion is split such that a first sub-window provides an information display and a second sub-window provides a camera presentation of a motor vehicle left-hand side view.

In another aspect, the third transparent display portion is split such that a third sub-window provides a message display having media information, and a fourth sub-window provides a camera presentation of a motor vehicle right-hand side view.

In another aspect, the second sub-window and the fourth sub-window change in transparency level from being substantially transparent when no object is present to be presented and are rendered less transparent when an object is present.

According to further aspects, the augmented reality projection data presented on the screen portion includes a colored lane symbol identifying a warned travel path of a second vehicle.

According to further aspects, the motor vehicle window defines a windshield, having the light emitting diode (OLED) screen positioned either between first and second glass panes of the windshield or in contact with a vehicle interior directed face of the windshield.

According to further aspects, the at least one transparent display portion includes a surface area that is selectively increased or decreased.

According to further aspects, a motor vehicle heads-up display system includes an organic light emitting diode (OLED) screen positioned in contact with a motor vehicle window. The OLED screen includes. A screen portion displays augmented reality (AR) projection data. Multiple transparent display portions individually display vehicle related data and infotainment related data different from the vehicle related data including at least: an instrument cluster display; a camera presentation of a motor vehicle left-hand side view; a camera presentation of a motor vehicle right-hand side view and; one of the multiple transparent display portions is positioned in direct line-of-sight view of a passenger of the motor vehicle.

In another aspect, turn-by-turn navigation information supplied by a vehicle GPS system is presented on multiple individual ones of the multiple transparent display portions.

In another aspect, the turn-by-turn navigation information includes: a navigational street map rendered in a first sub-window; and a next-turn map rendered in the screen portion.

In another aspect, the motor vehicle window defines a vehicle windshield, having the light emitting diode (OLED) screen positioned in contact with a vehicle interior directed face of the windshield.

In another aspect, the motor vehicle window defines a vehicle windshield, having the light emitting diode (OLED) screen positioned between first and second glass panes of the windshield.

According to further aspects, a motor vehicle heads-up display system includes an organic light emitting diode (OLED) screen positioned in contact with a motor vehicle window. The OLED screen includes a screen portion used to display augmented reality (AR) projection data; and multiple transparent display portions individually displaying vehicle related data and infotainment related data including at least a first transparent display portion, a second transparent display portion, and a third transparent display portion. A transparency level of each of the multiple transparent display portions can be varied. An instrument cluster display is presented on the first transparent display. A camera presentation of a motor vehicle left-hand side view is presented on the second transparent display. A camera presentation of a motor vehicle right-hand side view is presented on the third transparent display. One of the multiple transparent display portions is positioned in direct line-of-sight view of a passenger of the motor vehicle.

Further aspects, examples, and advantages will become apparent by reference to the following description and appended drawings wherein like reference numbers refer to the same component, element or feature.

### DRAWINGS

The drawings described herein are for illustration purposes only and are not intended to limit the scope of the present disclosure in any way.

FIG. 1 is a front elevational diagrammatic view of a heads-up display system according to aspects of the present disclosure; and

FIG. 2 is a front elevational view of a motor vehicle windshield having a heads-up display system of FIG. 1 showing a vehicle being tracked;

FIG. 3 is a front elevational view of a motor vehicle windshield having a heads-up display system of FIG. 1 showing a bicycle being tracked;

FIG. 4 is a front elevational view of the motor vehicle windshield of FIG. 2 further showing a third vehicle being tracked;

FIG. 5 is a front elevational view of a motor vehicle windshield having a heads-up display system of FIG. 1 during autonomous cruise;

FIG. 6 is a front elevational view of a motor vehicle windshield having a heads-up display system of FIG. 5 during manual drive mode with sub-windows retracted;

FIG. 7 is a front elevational view of a motor vehicle windshield having a heads-up display system of FIG. 1 showing an exemplary GPS navigation turn-by-turn display;

FIG. 8 is a front elevational view of a motor vehicle windshield having a heads-up display system of FIG. 1 showing a display during a blindspot sensed event;

FIG. 9 is a front elevational view of a motor vehicle windshield having a heads-up display system of FIG. 1 showing combination display information 80 via an optional transparent display portion positioned in direct view of a vehicle passenger;

FIG. 10 is a cross sectional side elevational view of a motor vehicle windshield according to aspects of the present disclosure; and

FIG. 11 is a cross sectional side elevational view of a motor vehicle windshield according to further aspects of the present disclosure.

### DETAILED DESCRIPTION

The following description is merely exemplary in nature and is not intended to limit the present disclosure, application, or uses.

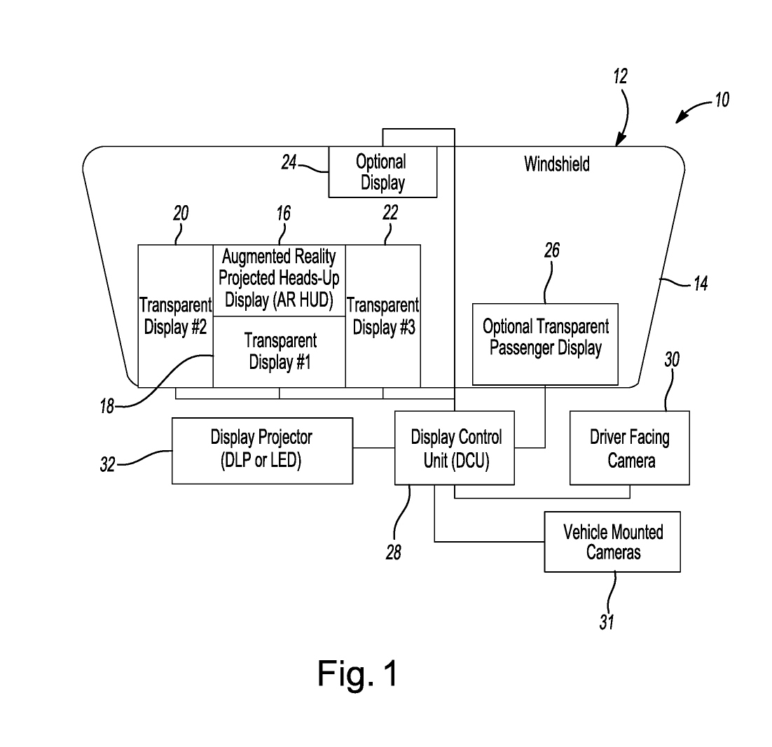

With reference to FIG. 1, a heads-up display (HUD) system is generally indicated with reference to HUD system 10. The HUD 10 includes a substantially transparent organic light emitting diode (OLED) screen 12 which is positioned on or adjacent to at least one glass pane of a motor vehicle window 14, such as a windshield, of a host vehicle or according to several aspects is positioned between glass panes of the vehicle window 14. The OLED screen 12 includes a screen portion 16 which provides space to display augmented reality (AR) projection data providing for example distances to proximate vehicles, directions of travel, lane identification, and the like. The screen portion 16 has a surface area which can be selectively increased or decreased. The OLED screen 12 further includes multiple transparent display portions each having a surface area which can be selectively increased or decreased, located in one or more locations on the vehicle window 14, and can display vehicle related and “infotainment” related information to the vehicle driver, either alone, or also to a vehicle passenger. Infotainment information as used herein includes but is not limited to media which provides one or both of information and entertainment, and also includes hardware and software products and systems which are built into, or can be added to the motor vehicle in order to enhance a driver's and/or a passenger's driving experience.

The multiple transparent displays can include a first transparent display portion 18 positioned below the screen portion 16. A second transparent display portion 20 is positioned to the driver's left of both of the screen portion 16 and the first transparent display portion 18 (looking forward or into the page as viewed in FIG. 1). A third transparent display portion 22 is positioned to the driver's right of both the screen portion 16 and the first transparent display portion 18. In addition, a first optional transparent display portion 24 can be located at any position proximate an upper edge of the OLED screen 12, and a second optional transparent display portion 26 can be positioned in direct view of a passenger of the motor vehicle. The shape of any of the transparent display portions can be rectangular as shown, or can be any geometric shape including circular, oval, square, or polygonal.

Each of the transparent display portions 18, 20, 22, 24, 26 is in communication with a display control unit (DCU) 28 which controls the content and selects a presentation of material transmitted for viewing by the transparent display portions. A driver facing camera 30 and multiple vehicle mounted (outward directed) cameras 31 are in communication with the DCU 28 to provide visual data to the DCU 28. According to several aspects, the cameras 31 include at least six cameras having two forward facing cameras to permit triangulation of distances to objects in front of the vehicle, two rear facing cameras to permit triangulation of distances to objects at the rear of the vehicle, a right hand side camera, and a left hand side cameral. A display projector 32 is also in communication with the DCU 28 to convert electronic signals received from the driver-facing camera 30 and the multiple vehicle mounted cameras 31 to a display format and to generate augmented reality data to the display screen 16.

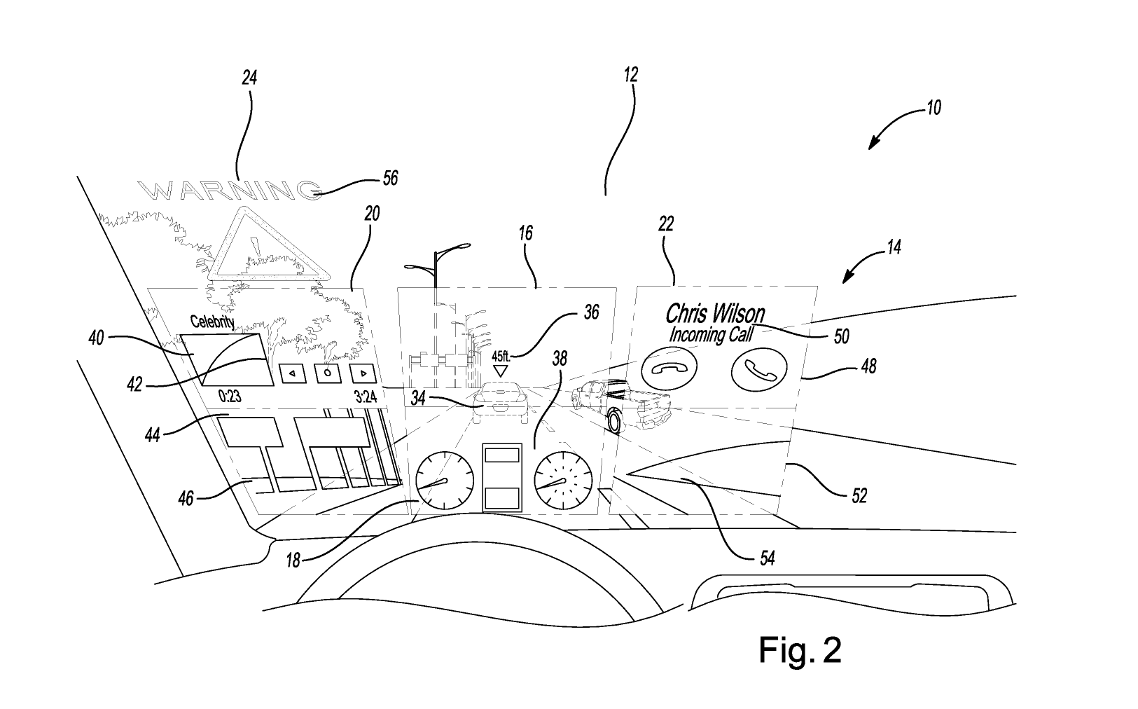

Referring to FIG. 2 and again to FIG. 1, an exemplary display image is shown for each of the transparent displays. In this aspect a second vehicle 34 is visible in the screen portion 16. Augmented reality data 34 is projected into the screen portion 16, such as a varying distance between the host vehicle and the second vehicle 34. An instrument cluster display 38 is presented in the first transparent display portion 18, which can include a vehicle speed, a vehicle direction, vehicle gas mileage, and the like. The second transparent display portion 20 is divided or split in this aspect such that a first sub-window 40 provides an information display 42 having information about an entertainment presentation being received and listened to and a second sub-window 44 provides a camera presentation 46 of a host vehicle left-hand side view. The third transparent display portion 22 is also divided or split in this aspect such that a third sub-window 48 provides a message display 50 having media information, for example a telephone call or a text message being received, and a fourth sub-window 52 provides a camera presentation 54 of a host vehicle right-hand side view.

It is noted that the second sub-window 44 providing the camera presentation 46 of the vehicle left-hand side view and the fourth sub-window 52 providing the camera presentation 54 of the vehicle right-hand side view can change in transparency level. For example, each can be substantially transparent when no vehicle or object is present to be presented. Alternately, these views can be rendered darker or less transparent if an object such as another vehicle or a pedestrian is present. The first optional transparent display portion 24 in the example aspect of FIG. 2 presents a pop-up warning 56. The pop-up warning 56 visually warns the operator of the host vehicle of the close proximity of the second vehicle 34, and an audible warning can also accompany the visual warning. The pop-up warning 56 can also similarly warn if an object such as another vehicle or a pedestrian is present in the range of the camera presentation 46 of the vehicle left-hand side view and/or the camera presentation 54 of the vehicle right-hand side view.

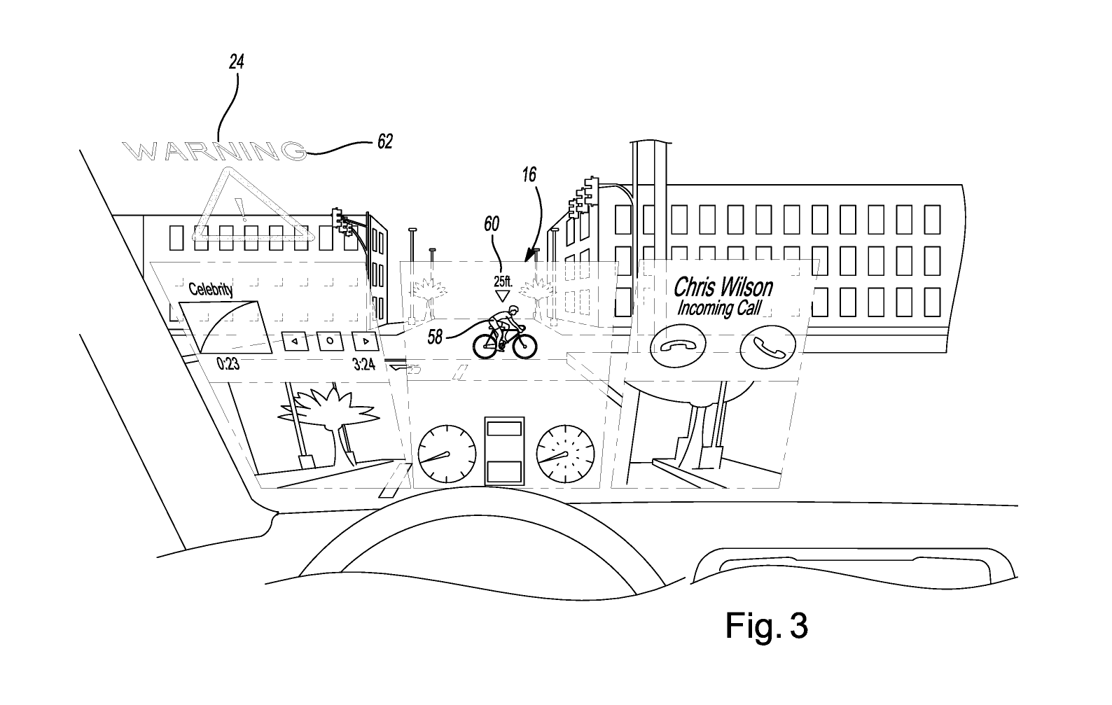

Referring to FIG. 3 and again to FIGS. 1 through 2, according to a further aspect, a bicycle 58 is visible in the screen portion 16, with the bicycle 58 travelling in a left-to-right direction as viewed by the driver of the host vehicle. Augmented reality data 60 is projected into the screen portion 16, such as a varying distance between the host vehicle and the bicycle 58. If the bicycle 58 is within a predetermined distance to the host vehicle, the first optional transparent display portion 24 in the example aspect of FIG. 3 presents a pop-up warning 62. The pop-up warning 62 visually and audibly warns the operator of the host vehicle of the crossing path of the bicycle 58 and provides an audible and visual warning to slow down.

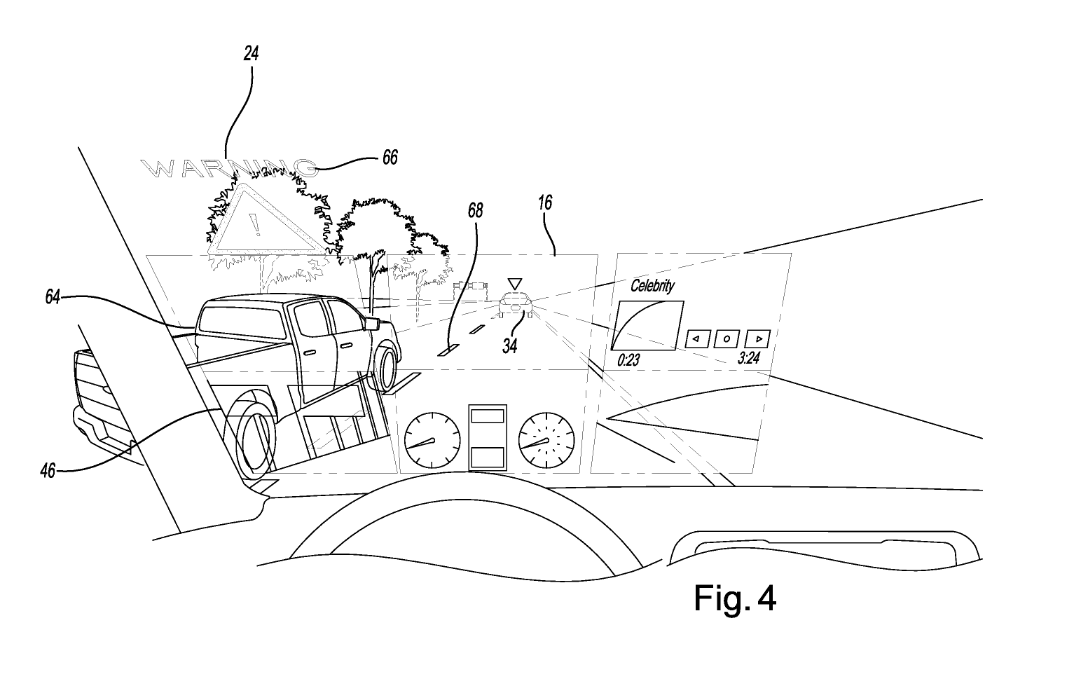

Referring to FIG. 4 and again to FIGS. 1 through 3, according to a further aspect, a third vehicle 64 is passing through the camera presentation 46 of the vehicle left-hand side view, with the third vehicle 64 travelling in a lane to the left of the host vehicle. Augmented reality data 68 is projected into the screen portion 16, such as a colored (for example red) striped lane symbol identifying the warned travel path of the third vehicle 64. The augmented reality data 68 is presented as a striped lane symbol in this aspect because the third vehicle 64 is passing beside the host vehicle and the host vehicle therefore can enter the lane being traveled by the third vehicle 64 when it is safe to do so. The first optional transparent display portion 24 in the example aspect of FIG. 4 presents a pop-up warning 66. The pop-up warning 66 visually and audibly warns the operator of the host vehicle of the presence of the third vehicle 64. It is noted that the second vehicle 34 in front of the host vehicle is spaced at a predetermined minimum distance from the host vehicle and is either travelling at the same or a greater speed, such that a warning concerning the second vehicle 34 is not required at this time.

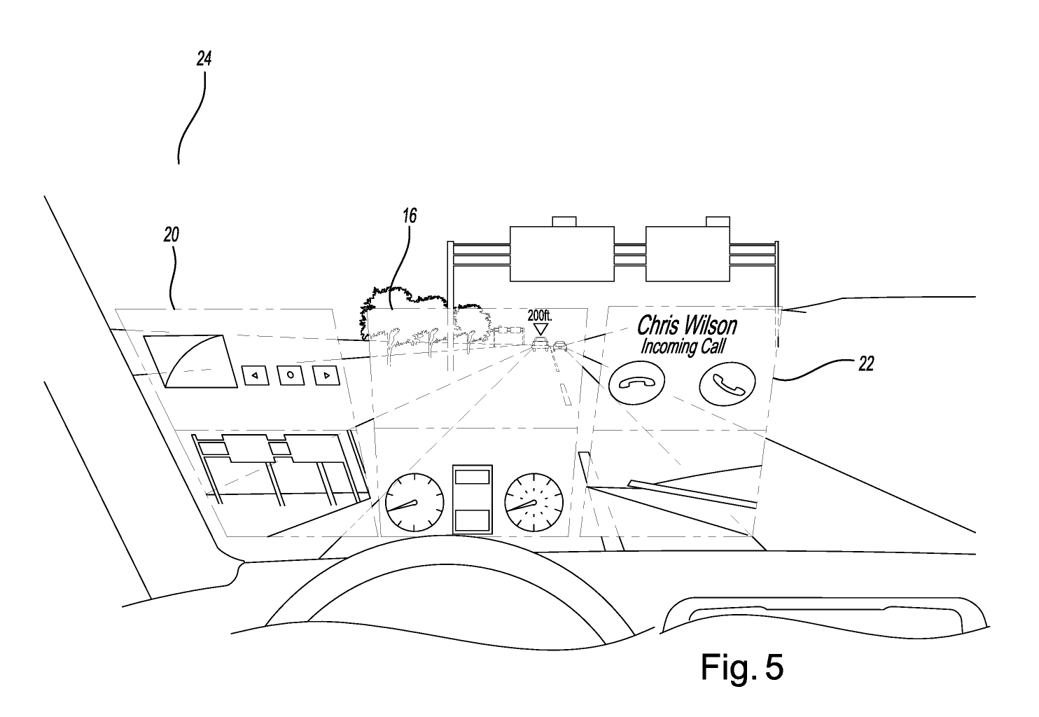

Referring to FIG. 5 and again to FIGS. 1 through 2, according to several aspects a condition is presented when there are no other vehicles, pedestrians, or other objects within a predetermined distance of the host vehicle. There are also no other vehicles or objects present in either of the camera presentation 46 of the vehicle left-hand side view or in the fourth sub-window 52 providing the camera presentation 54 of the vehicle right-hand side view. At this time there is no augmented reality data to present in the screen portion 16, and there are no pop-up warnings to present in the first optional transparent display portion 24. In this normal or autonomous cruise situation, the images presented in the second transparent display portion 20 and the third transparent display portion 22 are rendered darker and are therefore less transparent for greater visibility by the driver. The instrument cluster display 38 presented in the first transparent display portion 18 can be retained in brightness, or rendered brighter.

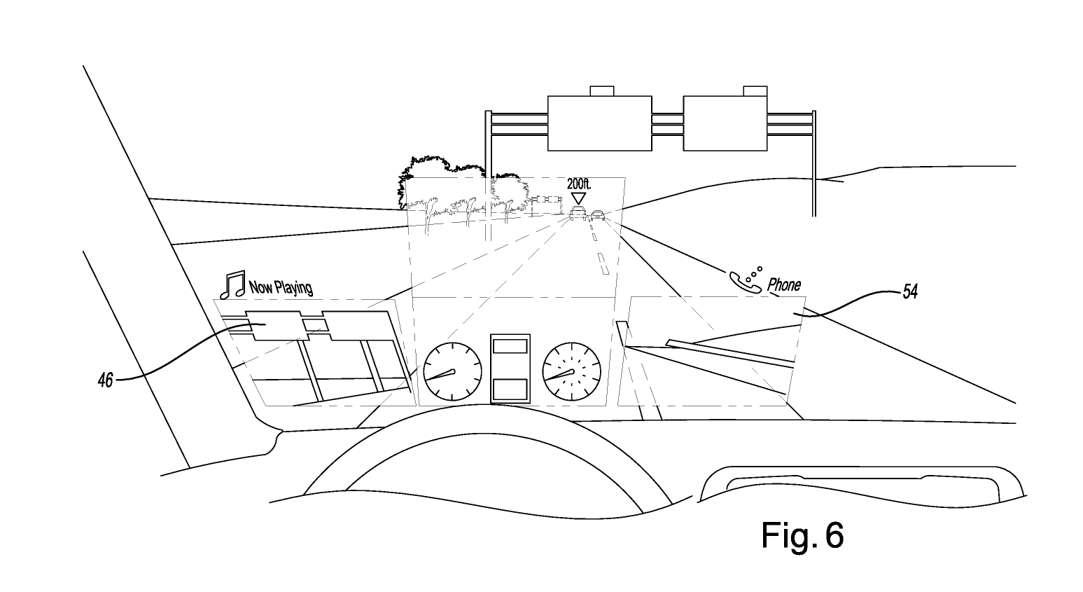

Referring to FIG. 6 and again to FIGS. 3 through 5, according to several aspects, the information display 42 in the first sub-window 40 and the message display 50 in the third sub-window 48 can be optionally retracted by the driver. At this time the second sub-window 44 providing the camera presentation 46 of the host vehicle left-hand side view and the camera presentation 54 of the host vehicle right-hand side view are still rendered, and are visible to the driver of the host vehicle. The visible images can be made more transparent if no other vehicle, object, or pedestrian are present, or can be rendered darker and less transparent if another vehicle, object, or pedestrian is presented in either or both of the sub-windows.

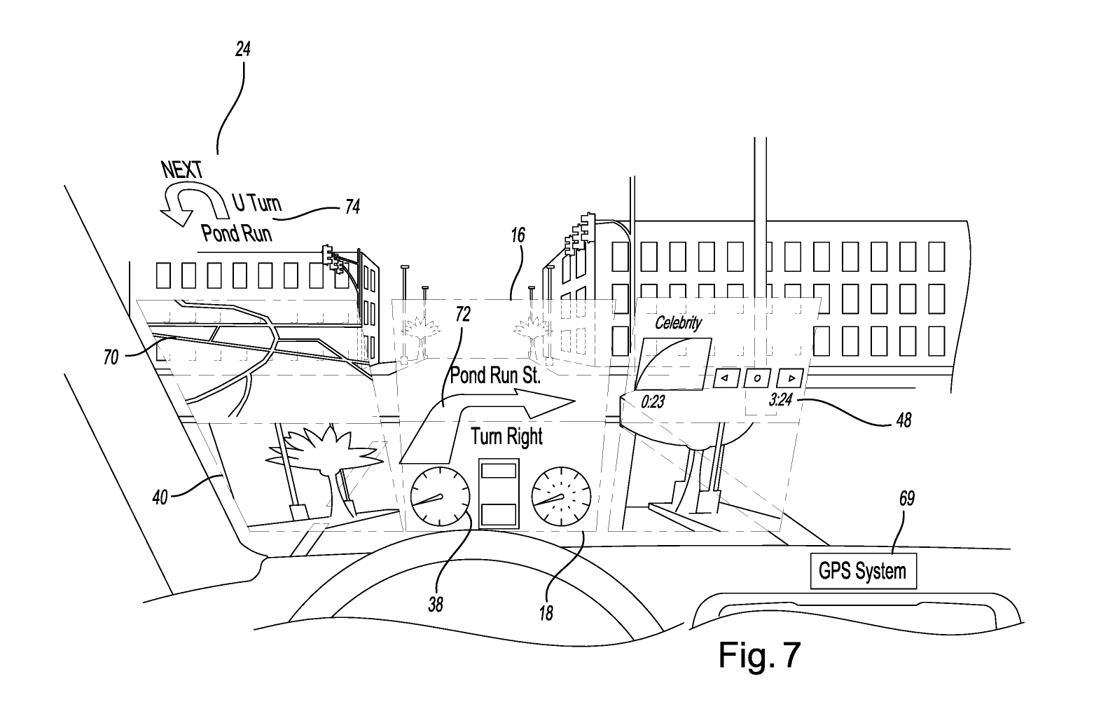

Referring to FIG. 7 and again to FIGS. 3 through 6, according to several aspects, the HUD system 10 can also be adapted to provide turn-by-turn navigation information supplied for example by a vehicle global positioning system (GPS) 69. In the example provided in FIG. 7, a navigational street map 70 is rendered in the first sub-window 40. A next-turn map 72 is rendered in the screen portion 16 because the screen portion 16 is the most readily visible area for this information. The instrument cluster display 38 continues to be rendered in the first transparent display portion 18. Optionally, upon selection by the driver the navigational street map 70 can be rendered in the third sub-window 48 in lieu of in the first sub-window 40.

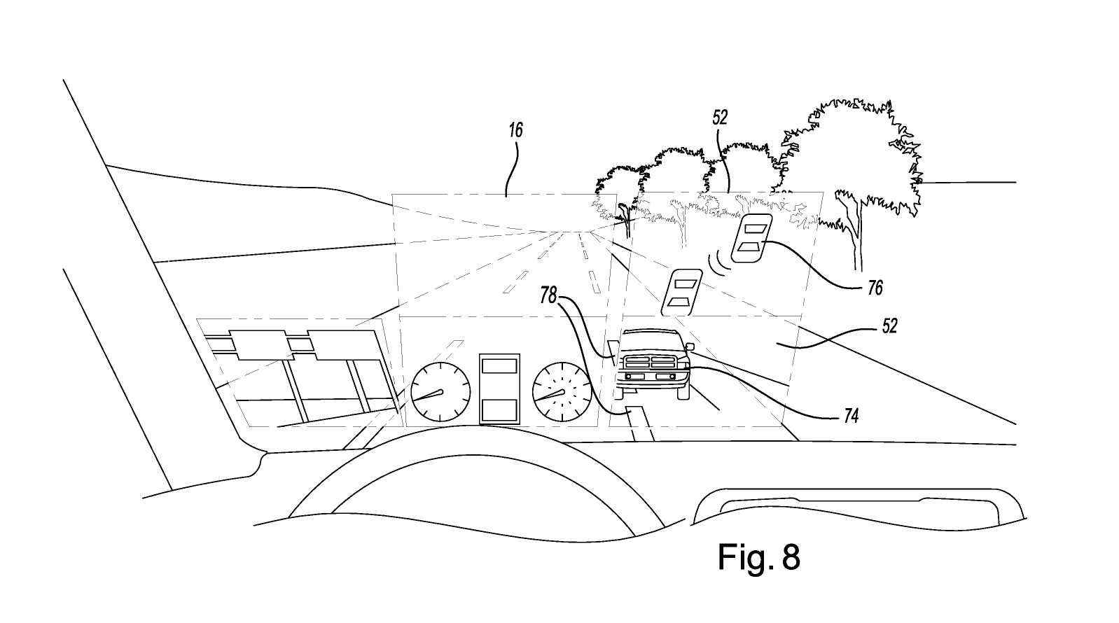

Referring to FIG. 8 and again to FIGS. 1 through 7, according to further aspects, a blindspot situation is dealt with as follows. For example, if a vehicle 74 is detected in the fourth sub-window 52, a blindspot pop-up warning 76 appears in the third sub-window 48. At the same time, augmented reality data 78 is projected into the screen portion 16, such as a colored (for example red) solid lane symbol identifying the anticipated lane of travel for the blindspot vehicle 74. The augmented reality data 78 is presented as a solid lane symbol in this aspect because the vehicle 74 is already present beside the host vehicle and the host vehicle therefore cannot enter the lane being traveled by the vehicle 74.

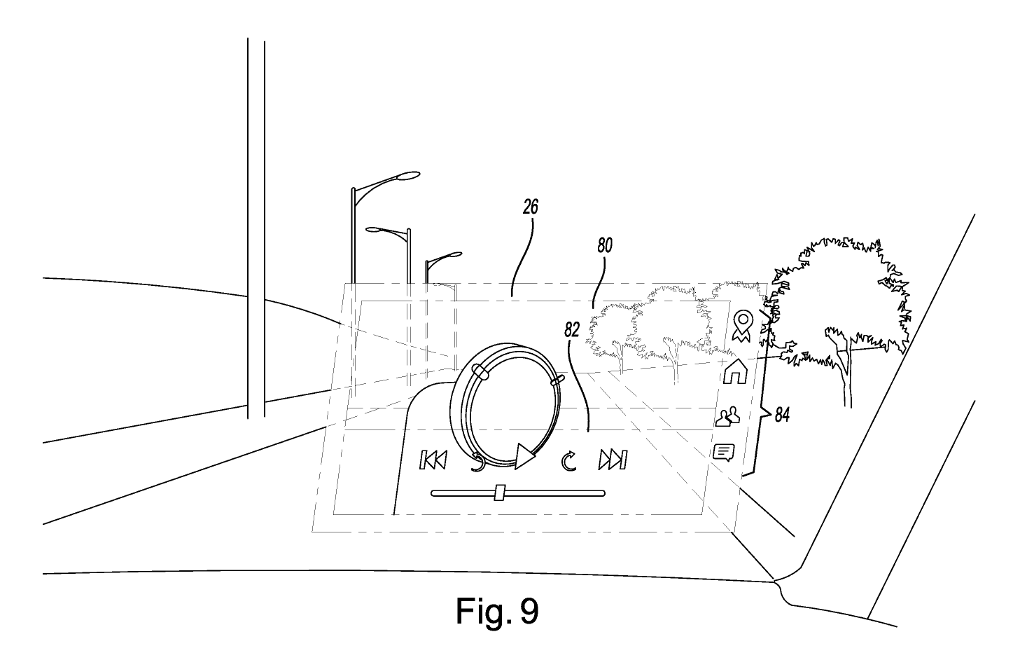

Referring to FIG. 9 and again to FIG. 1, according to further aspects, exemplary combination display information 80 is presented that can be displayed and accessed via the second optional transparent display portion 26 positioned in a direct line-of-sight view of the passenger of the host motor vehicle, and therefore not intended for direct viewing or interaction by the driver. Combination display information 80 can include, but is not limited to on-off, fast forward/reverse, and volume controls for phone, radio, and cassette disc (CD) system buttons 82, Internet, phone, message system buttons 84, and the like.

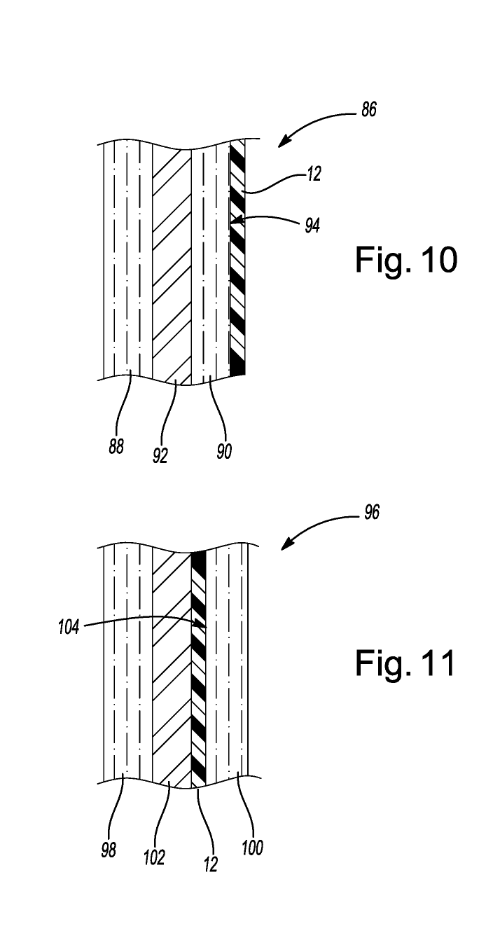

Referring to FIG. 10 and again to FIG. 1, according to several aspects, the HUD system 10 of the present disclosure can be mounted on a standard windshield assembly 86 having an outer facing glass pane 88, a vehicle interior facing glass pane 90 and a layer of polymeric material 92 positioned between the glass panes 88, 90. In this aspect, the OLED screen 12 is positioned on and in direct contact with an interior directed face 94 of the glass pane 90, thereby protecting the OLED screen 12 from exterior environmental conditions, while exposing the OLED screen 12 to the vehicle interior atmosphere.

Referring to FIG. 11 and again to FIG. 1, according to other aspects, the HUD system 10 of the present disclosure can be mounted on a windshield assembly 96 having an outer facing glass pane 98, a vehicle interior facing glass pane 100 and a layer of polymeric material 102 positioned between the glass panes 88, 90. In this aspect, the layer of polymeric material 102 is positioned in direct contact with one of the glass panes, such as the glass pane 98 shown. In this aspect, the OLED screen 12 is positioned on and in direct contact with a forward directed windshield interior face 104 of the glass pane 100, between the glass pane 100 and the layer of polymeric material 102, thereby protecting the OLED screen 12 from both the exterior environmental conditions and the vehicle interior atmosphere. It is noted the OLED screen 12 can alternately be positioned between the glass pane 98 and the layer of polymeric material 102.

According to several aspects, a motor vehicle heads-up display system 10 includes an organic light emitting diode (OLED) screen 12 positioned in contact with a motor vehicle windshield 14. The OLED screen 12 includes: a screen portion 16 used to display augmented reality (AR) projection data; and multiple transparent display portions 18, 20, 22, 24, 26 individually displaying vehicle related data and infotainment related data. The display portions include at least a first transparent display portion 18, a second transparent display portion 20, and a third transparent display portion 22, wherein a transparency level of each of the multiple transparent display portions can be varied. An instrument cluster display 38 is presented on the first transparent display 18. A camera presentation 46 of a motor vehicle left-hand side view is presented on the second transparent display 20. A camera presentation 54 of a motor vehicle right-hand side view is presented on the third transparent display 22. One of the multiple transparent display portions 26 is positioned in direct line-of-sight view of a passenger of the motor vehicle.

The description of the invention is merely exemplary in nature and variations that do not depart from the gist of the invention are intended to be within the scope of the invention. Such variations are not to be regarded as a departure from the spirit and scope of the invention.

The following is claimed:

1. A motor vehicle heads-up display system, comprising:
an organic light emitting diode (OLED) screen positioned in a motor vehicle in contact with a vehicle window, the OLED screen including:
a screen portion used to display augmented reality (AR) projection data; and
at least two transparent display portions individually displaying vehicle related data and infotainment related data including at least an instrument cluster display.

2. The motor vehicle heads-up display system of claim 1, wherein the at least two transparent display portions include a first transparent display portion, a second transparent display portion, and a third transparent display portion.

3. The motor vehicle heads-up display system of claim 2, wherein the first transparent display portion is positioned below the screen portion.

4. The motor vehicle heads-up display system of claim 2, wherein the second transparent display portion is positioned to a driver's left of both of the screen portion and the first transparent display portion, and the third transparent display portion is positioned to the driver's right of both the screen portion and the first transparent display portion.

5. The motor vehicle heads-up display system of claim 2, further including a display control unit in communication with the screen portion and each of the transparent display portions which controls a content and selects a presentation of material transmitted for viewing in the screen portion and each the transparent display portions.

6. The motor vehicle heads-up display system of claim 2, wherein the at least two transparent display portions include a first optional transparent display portion located at any position proximate an upper edge of the OLED screen.

7. The motor vehicle heads-up display system of claim 6, wherein the at least two transparent display portions include a second optional transparent display portion positioned in a direct line-of-sight view of a passenger of the motor vehicle.

8. The motor vehicle heads-up display system of claim 6, wherein the first optional transparent display portion presents a pop-up warning to visually warn the operator of the motor vehicle of:
a close proximity of a second vehicle; and
an object defining another vehicle or a pedestrian present in the range of a camera presentation of a vehicle left-hand side view or a camera presentation of a vehicle right-hand side view.

9. The motor vehicle heads-up display system of claim 2, wherein the second transparent display portion is split having a first sub-window providing an information display and a second sub-window providing a camera presentation of a motor vehicle left-hand side view.

10. The motor vehicle heads-up display system of claim 9, where the third transparent display portion is split such that a third sub-window provides a message display having media information, and a fourth sub-window provides a camera presentation of a motor vehicle right-hand side view.

11. The motor vehicle heads-up display system of claim 10, wherein the second sub-window and the fourth sub-window change in transparency level from being substantially transparent when no object is present to be presented and are rendered less transparent when an object is present.

12. The motor vehicle heads-up display system of claim 11, wherein the augmented reality projection data presented on the screen portion includes a colored lane symbol identifying a warned travel path of a second vehicle.

13. The motor vehicle heads-up display system of claim 1, wherein the motor vehicle window defines a windshield, having the light emitting diode (OLED) screen positioned either between first and second glass panes of the windshield or in contact with a vehicle interior directed face of the windshield.

14. The motor vehicle heads-up display system of claim 1, wherein the at least one transparent display portion includes a surface area that is selectively increased or decreased.

15. A motor vehicle heads-up display system, comprising an organic light emitting diode (OLED) screen positioned in a motor vehicle in contact with a motor vehicle window, the OLED screen including:
a screen portion used to display augmented reality (AR) projection data; and
multiple transparent display portions individually displaying vehicle related data and infotainment related data different from the vehicle related data, including at least:
an instrument cluster display;
a camera presentation of a motor vehicle left-hand side view;
a camera presentation of a motor vehicle right-hand side view and;
one of the multiple transparent display portions is positioned in direct line-of-sight view of a passenger of the motor vehicle.

16. The motor vehicle heads-up display system of claim 15, wherein turn-by-turn navigation information supplied by a vehicle GPS system is presented on multiple individual ones of the multiple transparent display portions.

17. The motor vehicle heads-up display system of claim 16, wherein the turn-by-turn navigation information includes:
a navigational street map rendered in a first sub-window; and
a next-turn map rendered in the screen portion.

18. The motor vehicle heads-up display system of claim 15, wherein the motor vehicle window defines a vehicle windshield, having the light emitting diode (OLED) screen positioned in contact with a vehicle interior directed face of the windshield.

19. The motor vehicle heads-up display system of claim 15, wherein the motor vehicle window defines a vehicle windshield, having the light emitting diode (OLED) screen positioned between first and second glass panes of the windshield.

20. A motor vehicle heads-up display system, comprising an organic light emitting diode (OLED) screen positioned in a motor vehicle in contact with a motor vehicle windshield, the OLED screen including:
a screen portion used to display augmented reality (AR) projection data; and
multiple transparent display portions individually displaying vehicle related data and infotainment related data including at least a first transparent display portion, a second transparent display portion, and a third transparent display portion, wherein a transparency level of each of the multiple transparent display portions can be varied; wherein:
an instrument cluster display is presented on the first transparent display;
a camera presentation of a motor vehicle left-hand side view is presented on the second transparent display;
a camera presentation of a motor vehicle right-hand side view is presented on the third transparent display; and
one of the multiple transparent display portions is positioned in direct line-of-sight view of a passenger of the motor vehicle.
